(19) United States
(12) Patent Application Publication
(10) Pub. No.: US 2026/0233045 A1
(43) Pub. Date: Aug. 13, 2026

(54) FIRE RETARDANT COMPOSITIONS CONTAINING ONE OR MORE SURFACTANTS

(71) Applicant: PERIMETER SOLUTIONS LP, Clayton, MO (US)

(72) Inventors: Jinxue JIANG, Rancho Cucamonga, CA (US); Marcela MUNOZ, Fontana, CA (US); Melissa KIM, Ontario, CA (US)

(21) Appl. No.: 19/385,271

(22) Filed: Nov. 11, 2025

Related U.S. Application Data
(60) Provisional application No. 63/719,223, filed on Nov. 12, 2024.

(51) Int. Cl. A62D 1/00

(52) U.S. Cl. CPC A62D 1/0042

(57) ABSTRACT

The present invention relates to fire retardant compositions containing a fire retardant component and a surfactant and exhibiting improved wetting characteristics for wildland fire fuel material and/or improved fire retardant performance.

### REFERENCE TO RELATED APPLICATIONS

This application claims the benefit of, and priority to, U.S. Provisional Patent Application Ser. No. 63/719,223, filed Nov. 12, 2024, the entire contents of which are hereby incorporated by reference for all relevant purposes as if fully set forth herein.

### FIELD OF THE INVENTION

The present invention relates to fire retardant compositions containing a fire retardant component and a surfactant and exhibiting improved wetting characteristics for wildland fire fuel material and/or improved fire retardant performance.

### BACKGROUND OF THE INVENTION

Often, large-scale wildfires occur in areas such as western regions of the United States, including densely populated areas, and may cause significant damage to both individuals and property. Such fires and damage may occur on an annual basis. The use of fire retardant chemicals has been known to be an effective way to prevent and combat wildfires for decades. Generally, fire retardant compositions are known to be effective for decreasing the flammability and/or combustibility of materials, including wildland vegetation such as forest and grassy materials, and for increasing the resistance of these materials to heat and flame damage. The United States Forest Service (USFS) has established standards for firefighting compositions including those containing fire retardants (e.g., long-term fire retardants), foam fire suppressants, and water enhancers. It is to be understood that use of the term “fire retardant” herein without the designation “long-term” does not indicate the retardant is not a long-term fire retardant as understood generally or in accordance with USFS standards.

In particular, the USFS has established standards requiring that retardants, including long-term retardants should contain retardant chemicals that alter the way the fire burns, decrease the fire intensity, and/or slow the advance of the fire, even after the water they originally contained has evaporated. Different fire retardant chemicals have different properties, responses and/or reaction mechanisms in the presence of a heat or fire source. Accordingly, various fire retardant compositions have been explored to combat fire damage, including that from wildland vegetation.

Over the past decades, retardants, in particular long-term retardants have been focused on those chemicals which can convert the wildland vegetation from a substance that is flammable and, consequently, a fuel, to a chemically modified or converted substance with difficulty of igniting and providing fuel source when subjected to heat and beyond its ignition point for starting a fire. Ammonium phosphate based long-term retardants belong to this category, which perform under a condensed-phase fire retardant mechanism having a char formation model. This type of retardant undergoes thermal degradation at elevated temperature to generate pyrophosphoric acids, which can catalyze dehydration of carbohydrate materials to form an insulating char layer on the surface of the potential fuel source and reduce the release of volatile combustible gases.

Fire retardant concentrate compositions comprising mixtures of monoammonium phosphate, diammonium phosphate and/or ammonium polyphosphate for combating wildfire either directly onto flaming fuel or indirectly onto the fuel ahead of a potentially advancing fire front are known. Fire retardant compositions comprising ammonium phosphate mixtures as effective wildfire retardants with decreased corrosion to metals and decreased aquatic toxicity are also known. As indicated, various fire retardant compositions for combating wildfire are based on phosphate chemicals and have a fire retardant mechanism based on condensed-phase char formation. Such phosphate based compounds have been proven effective as fire retardant chemicals, making them useful in wildfire retardant formulations.

### BRIEF SUMMARY OF THE INVENTION

Various aspects of the present invention are directed to liquid fire retardant compositions, the compositions comprising: a fire retardant component comprising monoammonium phosphate (MAP), diammonium phosphate (DAP), ammonium polyphosphate (APP), phosphoric acid, and combinations thereof; a surfactant selected from anionic surfactants, nonionic surfactants, and amphoteric surfactants, and combinations thereof; one or more optional corrosion inhibitors; one or more optional thickeners; and water. The compositions satisfy one or more of the following: the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1; the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the surface tension of the composition is at least about 30 mN/m, at least about 35 mN/m, at least about 40 mN/m, at least about 45 mN/m, or at least about 50 mN/m.

Other aspects of the present invention are directed to liquid fire retardant compositions, the compositions comprising a fire retardant component comprising a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9; a surfactant selected from anionic surfactants, nonionic surfactants, and amphoteric surfactants, and combinations thereof; one or more optional corrosion inhibitors; water; and one or more optional thickeners. The compositions satisfy one or more of the following: the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the surface tension of the composition is at least about 30 mN/m, at least about 35 mN/m, at least about 40 mN/m, at least about 45 mN/m, or at least about 50 mN/m.

Other aspects of the present invention are directed to fire retardant concentrate compositions, the compositions comprising: a fire retardant component comprising monoammonium phosphate (MAP), diammonium phosphate (DAP), ammonium polyphosphate (APP), and combinations thereof, a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %; one or more optional corrosion inhibitors, wherein the one or more optional corrosion inhibitors are present in a concentration of at least about 1 wt %, or from about 1 wt to about 3 wt %; and one or more optional thickeners, wherein the one or more optional thickeners are present in a concentration of at least about 1 wt %, or from about 1 wt % to about 3 wt %. The compositions satisfy one or more of the following: the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1; the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

Further aspects of the present invention are directed to fire retardant concentrate composition, the compositions comprising: a fire retardant component comprising a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9; a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %; one or more optional corrosion inhibitors, wherein the one or more optional corrosion inhibitors are present in a concentration of at least about 1 wt %, or from about 1 wt to about 3 wt %; and one or more optional thickeners, wherein the one or more optional thickeners are present in a concentration of at least about 1 wt %, or from about 1 wt % to about 3 wt %. The compositions satisfy one or more of the following: the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

Still further aspects of the present invention are directed to liquid fire retardant compositions, the compositions comprising: a fire retardant component comprising a phosphate fire retardant, wherein the fire retardant component constitutes at least about 85 wt % of the composition; a surfactant selected from anionic surfactants, nonionic surfactants, and amphoteric surfactants, and combinations thereof, wherein the surfactant constitutes from about 0.01 wt % to about 1 wt % of the composition; one or more optional corrosion inhibitors, wherein the weight ratio of the surfactant to the one or more optional corrosion inhibitors is from 0.01:1 to 1:1; one or more optional pigments, wherein the weight ratio of the surfactant to the one or more optional pigments is from 0.01:1 to 1:1; and one or more optional thickeners, wherein the weight ratio of the surfactant to the one or more optional pigments is from 0.01:1 to 1:1, wherein the liquid fire retardant composition has a surface tension that varies no more than 50% from the surface tension of water.

Additional aspects of the present invention are directed to liquid fire retardant compositions, the compositions comprising: a fire retardant component comprising a phosphate fire retardant and a non-phosphate fire retardant, wherein the phosphate fire retardant constitutes at least about 50 wt % of the fire retardant component; a surfactant selected from anionic surfactants, nonionic surfactants, and amphoteric surfactants; and one or more optional components selected from corrosion inhibitors, pigments, thickeners, and combinations thereof, wherein: the phosphate fire retardant comprises monoammonium phosphate (MAP), diammonium phosphate (DAP), ammonium polyphosphate (APP), phosphoric acid or a combination thereof; the non-phosphate fire retardant is selected from the group consisting of potassium carbonate, potassium bicarbonate, sodium carbonate, sodium bicarbonate, ammonium carbonate, ammonium bicarbonate, magnesium chloride, magnesium sulfate, ammonium chloride, ammonium bromide, ammonium sulfate, urea, dicyandiamide, melamine, cyanamide or a combination of thereof; the surfactant constitutes from about 0.01 wt % to about 1.0 wt % or from about 0.01 wt % to about 0.5 wt %; and the liquid fire retardant composition has a surface tension that varies no more than 50% from the surface tension of water.

Various other aspects of the present invention are directed to liquid fire retardant compositions, the compositions comprising: a fire retardant component comprising a phosphate fire retardant, wherein the phosphate fire retardant constitutes at least about 50 wt % of the fire retardant component; an anionic surfactant, wherein the anionic surfactant constitutes from about 0.01 wt % to about 1 wt % of the composition; and one or more optional components selected from corrosion inhibitors, pigments, thickeners, and combinations thereof, wherein: the liquid fire retardant composition has a surface tension that varies no more than 50% from the surface tension of water; and the anionic surfactant is selected from sulfonate type anionic surfactants selected from the group consisting of sodium pentanesulfonate, butylnaphtalenesulfonic acid sodium salt, sodium 1-butanesulfonate, lignofulonic acid calcium salt, sodium dodecylbenzene sulfonate, sodium allylsulfonate, sodium lignosulfonate, calcium dodecylbenzene sulfonate, 2-dodecylbenzenesulfonate, sodium alkylbenzene sulfonate, disodium methylenebisnaphthalenesulfphonate, ammonium dodecylbenzenesulphonate, linear alklybenzene sulfonates, and combinations thereof; and/or the anionic surfactant is selected from sulfate type anionic surfactants selected from the group consisting of lithium dodecyl sulfate, sodium octyl sulfate, sodium dodecyl sulfate, sodium decyl sulfate, ammonium layryl sulfate, sodium lauryl polyoxyethylene ether sulfate, sodium lauryl sulfate, and combinations thereof; and/or the anionic surfactant is selected from sulfosuccinate type anionic surfactants selected from the group consisting of sodium diisobutyl sulfosuccinate, dihexyl sodium sulfosuccinate, sodium diamyl sulfosuccinate, dicyclohexyl sulfosuccinate sodium salt, disodium 4-[2-[(1-oxoundec-10-enyl)amino]ethyl] 2-sulphonatosuccinate, and combinations thereof; and/or the anionic surfactant is selected from fatty acid salt type anionic surfactants selected from the group consisting of sodium stearate, magnesium stearate, potassium oleate, hydroxyaluminum distearate, and combinations thereof; and/or the anionic surfactant is selected from other types selected from of anionic surfactants comprising of organosilicon surfactant, fluorocarbon surfactant, fatty alcohol ammonium sulfate, soaps, and combinations thereof.

Additional aspects of the present invention are directed to liquid fire retardant compositions, the compositions comprising: a fire retardant component comprising a phosphate fire retardant, wherein the phosphate fire retardant constitutes at least about 50 wt % of the fire retardant component; a nonionic surfactant, wherein the nonionic surfactant constitutes from about 0.01 wt % to about 1 wt % of the composition; and one or more optional components selected from corrosion inhibitors, pigments, thickeners, and combinations thereof, wherein the liquid fire retardant composition has a surface tension that varies no more than 50% from the surface tension of water; and the nonionic surfactant is selected from polyethylene glycol monooleyl ether, polyethylene glycol monocetyl ether, polysorbate 20, polysorbate 40, Tween 60, Tween 80, polyoxyethylene lauryl ether, Span 60, dibenzyl biphenyl polyoxyethylene ether, fatty alcohol polyoxyethylene ether, alky polyglucoside, lauryl polyglucoside, sorbitan sesquioleate, silicone polyethers, and combinations thereof.

Still further aspects of the present invention are directed to liquid fire retardant compositions, the composition comprising: a fire retardant component comprising a phosphate fire retardant, wherein the phosphate fire retardant constitutes at least about 50 wt % of the fire retardant component; an amphoteric surfactant, wherein the amphoteric surfactant constitutes from about 0.01 wt % to about 1 wt % of the composition; and one or more optional components selected from corrosion inhibitors, pigments, thickeners, and combinations thereof, wherein: the liquid fire retardant composition has a surface tension that varies no more than 50% from the surface tension of water; and the amphoteric surfactant is selected from lauryl betaine, sodium lauroamphoacetate, lauramidopropyl betaine, cocoamidopropyl betaine, coco alkyldimethyl betaine, and combinations thereof.

The present disclosure is further directed to fire retardant solutions prepared from any of the compositions (e.g., concentrates) of the present invention. The present invention is also directed to methods for combating fires utilizing compositions of the present invention.

Other objects and features will be in part apparent and in part pointed out hereinafter.

### BRIEF DESCRIPTION OF THE FIGURES

FIGS. 1 and 2 display the results of mass loss calorimeter tests for treated wood excelsior beds as described in Example 23.

### DETAILED DESCRIPTION OF THE INVENTION

The present disclosure is generally directed to fire retardant compositions (e.g., fire retardant concentrate compositions and solutions prepared by the dilution thereof) including one or more surfactants along with a fire retardant component and other optional suitable components. In accordance with various embodiments, it is currently believed that incorporating the surfactant(s) provides a fire retardant formulation exhibiting one or more advantageous properties.

For example, it is currently believed the use of the surfactants in accordance with the present disclosure may lead to increased fire retardant performance and/or more efficient use of the fire retardant allowing reduced use of fire retardant chemicals when combating wildfires. It is currently believed the individual surfactants and mixtures thereof lower the surface tension of aqueous fire retardant solutions, thus increasing the solution's capacity to wet and penetrate the fuel surface. It is believed that the deeper penetration of aqueous fire retardant solutions in the forest fuel bed results in a thicker layer of reduced/non-flammable barrier, thus increasing the effectiveness of fire retardancy. It is also believed that the improved wettability of fire retardant solutions on the forest fuel pack contributes to improved effectiveness in firefighting by causing significant delay of ignition/combustion of the fuels. The improved distribution of fire retardant solutions within the forest fuel pack could also lead to higher charring rate and consequently allow a lower usage of retardant chemicals. In various aspects of the present invention, it is believed that improved performance is provided in connection with hydrophobic surface fuels. Overall, therefore, it is currently believed these improved fire retardant solutions exhibit superior wetting ability and performance to provide effectiveness in firefighting and often provide one or more of the above-noted advantages in terms of performance and/or reduced usage of fire retardants.

Various aspects of the present disclosure therefore are related to compositions for use therein and methods for combatting wildfires where less fire retardant is required to provide performance equivalent to other fire retardant compositions and/or improved performance is provided by the compositions and methods described herein by an equivalent amount of fire retardant used in other fire retardant compositions.

### Fire Retardant

Suitable fire retardants include phosphate and phosphorus-based fire retardants including monoammonium phosphate (MAP), diammonium phosphate (DAP), ammonium polyphosphate (APP), phosphoric acid, and combinations thereof. Any of the formulations described herein may comprise at least one ammonium phosphate. In certain embodiments, the ammonium phosphate comprises, consists essentially of, or consists of monoammonium phosphate (MAP). In other embodiments, the ammonium phosphate comprises, consists essentially of, or consists of diammonium phosphate (DAP). In still other embodiments, the ammonium phosphate comprises, consists essentially of, or consists of ammonium polyphosphate (APP). In other embodiments, the fire retardant comprises, consists essentially of, or consists of phosphoric acid.

In some embodiments, the formulations comprise a mixture of ammonium phosphates. In certain embodiments, the ammonium phosphate or mixture of ammonium phosphates has a molar ratio of ammoniacal nitrogen to phosphorus (N/P ratio) in a range from about 1.1 to about 1.9. In certain embodiments, the ammonium phosphate or mixture of ammonium phosphates has a molar ratio of ammoniacal nitrogen to phosphorus (N/P ratio) in a range from about 1.2 to about 1.8, from about 1.3 to about 1.7, from about 1.35 to about 1.65. In certain embodiments, the ammonium phosphate or mixture of ammonium phosphates has a molar ratio of ammoniacal nitrogen to phosphorus (N/P ratio) in a range from about 1.4 to about 1.6. In certain embodiments, the ammonium phosphate or mixture of ammonium phosphates has a molar ratio of ammoniacal nitrogen to phosphorus (N/P ratio) in a range from any of about 1.1, 1.2, 1.3, 1.35, 1.4, 1.5, 1.6, 1.7, or 1.8 to any of about 1.2, 1.3, 1.4, 1.5, 1.6, 1.65, 1.7, 1.8, or 1.9.

Where incorporating less ammonium phosphates and therefore less ammonia, formulations of the present invention may result in a lower aquatic toxicity.

In various embodiments, the composition or fire retardant component includes a mixture of ammonium phosphates, typically at least two ammonium phosphates. In certain embodiments, the mixture of ammonium phosphates comprises, consists essentially of, or consists of monoammonium phosphate (MAP) and diammonium phosphate (DAP). In certain embodiments, the MAP contains from about 10% or 11% to about 12% ammonia by weight and from about 40% or 55% to about 61% phosphorus pentoxide by weight. In certain embodiments, the DAP contains from about 16% to about 21% ammonia by weight and from about 40% to about 54% phosphorus pentoxide by weight. Further, in certain embodiments, the weight ratio of MAP to DAP is in the range of from about 5% to about 60% MAP to about 40% to about 95% DAP of the total ammonium phosphate in the concentrate. In certain embodiments, the weight ratio of MAP to DAP is in the range of from about 40% to about 60% MAP to about 40% to about 60% DAP of the total ammonium phosphate in the concentrate. In certain embodiments, the weight ratio of MAP to DAP is in the range of from about 50% to about 60% MAP to about 40% to about 50% DAP of the total ammonium phosphate in the concentrate.

In further embodiments, the composition comprises from about 19% to about 50% by weight of DAP. The composition can comprise from about 19% to about 47% by weight of DAP. For example, the composition can comprise from about 20% to 30% of DAP. In some instances, the composition comprises from about 25% to about 27% by weight of DAP (e.g., about 26%).

In further embodiments, the composition comprises from about 1% to about 30% of MAP. The composition can comprise from about 10% to about 30% of MAP. For example, the composition can comprise from about 20% to about 30% by weight of MAP. In some instances, the composition comprises from about 22% to about 24% by weight of MAP (e.g., about 23%).

Incorporating the MAP and DAP within certain preferred ratios may enhance the solubility of the ammonium phosphates. Therefore, in certain embodiments, the weight ratio of MAP to DAP is from about 40:60 to about 60:40, or from about 45:55 to about 55:45 (e.g., about 46:54 or about 47:53).

In certain embodiments incorporating ammonium polyphosphate, the APP contains from about 12% to about 17% ammonia by weight and from about 68% to about 75% phosphorus pentoxide by weight. In these and other embodiments, the weight ratio of APP to MAP and/or DAP is in the range of from about 5% to about 60% APP to about 40% to about 95% MAP and/or DAP of the total ammonium phosphate in the concentrate. In certain embodiments, the weight ratio of APP to MAP and/or DAP is in the range of from about 40% to about 60% APP to about 40% to about 60% MAP and/or DAP of the total ammonium phosphate. In certain embodiments, the weight ratio of APP to MAP and/or DAP is in the range of from about 50% to about 60% APP to about 40% to about 50% MAP and/or DAP of the total ammonium phosphate.

Compositions of the present disclosure include fire retardant solutions prepared by mixing a fire retardant composition (e.g., a concentrate composition), as described anywhere herein, with water to form an aqueous solution. Suitable concentrate compositions include liquid concentrate compositions and powder (e.g., dry) concentrate compositions.

In certain embodiments (e.g., fire retardant solutions or final formulations ready for use), the fire retardant component is present in a concentration of at least about 3 wt %, at least about 4 wt %, at least about 5 wt %, at least about 6 wt %, at least about 7 wt %, at least about 8 wt, at least about 9 wt %, or at least about 10 wt %; and/or present in a concentration of less than about 20 wt %, less than about 18 wt %, less than about 16 wt %, less than about 14 wt %, less than about 12 wt %, or less than about 10 wt %.

For example, in certain embodiments, the fire retardant component is present in a concentration of from about 4 wt % to about 18 wt %, from about 6 wt % to about 16 wt %, from about 8 wt % to about 14 wt %, or from about 10 wt % to about 12 wt %.

Concentrate compositions may include the fire retardant component in a concentration of at least about 30 wt %, at least about 35 wt %, at least about 40 wt %, at least about 45 wt, at least about 50 wt %, at least about 55 wt %, at least about 60 wt %, at least about 65 wt %, at least about 70 wt %, or at least about 75 wt % of the composition. Such compositions may include the fire retardant in a concentration above any or all these lower limits and less than about 90 wt %, less than about 85 wt %, less than about 80 wt %, less than about 75 wt %, less than about 70 wt %, less than about 65 wt %, less than about 60 wt %, less than about 55 wt %, or less than about 50 wt % of the composition.

In addition to the phosphate retardants discussed herein, the formulations of the present invention may include other fire retardants. These other retardants may be incorporated as the primary, or even lone fire retardant or may be incorporated along with a phosphate retardant. In any case, these other retardants may be incorporated in accordance with the discussion herein regarding phosphate retardants and suitable concentrations, ratios, etc.

Other suitable fire retardants include alkali metal carbonate salts selected from the group consisting of potassium carbonate, potassium bicarbonate, sodium carbonate, sodium bicarbonate, lithium carbonate, ammonia carbonate, ammonia bicarbonate and combinations thereof.

Additional suitable fire retardants include a magnesium chloride fire retardant selected from MgCl₂ and magnesium chloride hydrates (MgCl₂·(H₂O)ₓ, where x is 1, 2, 4, 6, 8, or 12); and/or a magnesium sulfate fire retardant selected from MgSO₄ magnesium sulfate hydrates (MgSO₄·(H₂O)ₓ, where x is 1, 2, 3, 4, 5, 6, 7, 9, 10 or 11).

Other suitable fire retardants include ammonium chloride, ammonium bromide, ammonium sulfate, urea, dicyandiamide, melamine, cyanamide, and combinations thereof.

### Surfactants

As noted, the surfactants utilized in accordance with the present invention are currently believed to provide various performance benefits, including those based on the improved wetting ability of the formulation based on the surfactant(s) utilized. The surfactants may be selected from those listed herein and incorporated in the concentrations, relative proportions (ratios), etc. described herein. Various aspects of the present invention involve incorporating the surfactants (typically along with other components such as corrosion inhibitors, thickeners, etc.) that provide novel formulations and/or that provide fire retardant formulations exhibiting one or more performance improvements described herein. These performance improvements may be characterized in terms of formulation properties (e.g., surface tension, viscosity, etc.) and/or improved performance as determined by laboratory or field tests, including following US Forest Service Long-term Retardant, Wildland Firefighting Specification 5100-304d, January 2020, including any and all amendments and updates to this Specification and/or any other regulations or requirements developed by the USFS. Various other compositions may nonetheless provide performance benefits without necessarily qualifying under any USFS standards.

Suitable surfactants include anionic surfactants, nonionic surfactants, amphoteric surfactants, and combinations thereof. Generally, they may be included in a proportion of from about 0.01 wt % to about 1 wt % of the composition. In certain embodiments, amphoteric surfactants are preferably chosen as they have been observed in certain formulations to provide lower surface tension even when incorporated at a relatively low loading/concentration in the fire retardant solution.

Typically, a surfactant is present in a concentration of at least about 0.01 wt %, at least about 0.03 wt %, at least about 0.05 wt %, at least about 0.07 wt %, at least about 0.1 wt %, at least about 0.12 wt %, or at least about 0.15 wt %. The surfactant may typically also be incorporated in a concentration of less than about 1 wt %, less than about 0.75 wt %, less than about 0.5 wt %, less than about 0.25 wt %, or less than about 0.15 wt %.

For example, in certain embodiments, the surfactant is present in a concentration of from about 0.01 wt % to about 0.5 wt %, from about 0.03 wt % to about 0.25 wt %, or from about 0.05 wt % to about 0.15 wt % (e.g., about 0.1 wt %).

Concentrate compositions may include a surfactant selected from anionic surfactants, nonionic surfactants, and amphoteric surfactants, and combinations thereof, in a concentration of at least about 0.5 wt %, or from about 0.5 wt % to about 1.5 wt %.

### Anionic Surfactants

Suitable anionic surfactants include sulfonate type anionic surfactants selected from the group consisting of sodium pentanesulfonate, butylnaphtalenesulfonic acid sodium salt, sodium 1-butanesulfonate, lignofulonic acid calcium salt, sodium dodecylbenzene sulfonate, sodium allylsulfonate, sodium lignosulfonate, calcium dodecylbenzene sulfonate, 2-dodecylbenzenesulfonate, sodium alkylbenzene sulfonate, disodium methylenebisnaphthalenesulfphonate, ammonium dodecylbenzenesulphonate, linear alklybenzene sulfonates, and combinations thereof.

In various embodiments, the composition comprises the anionic surfactant comprises sodium dodecylbenzene sulfonate (SDBS).

Further in accordance with the present invention, the surfactant may comprise an anionic surfactant selected from sulfate type anionic surfactants selected from the group consisting of lithium dodecyl sulfate, sodium octyl sulfate, sodium dodecyl sulfate, sodium decyl sulfate, ammonium layryl sulfate, sodium lauryl polyoxyethylene ether sulfate, sodium lauryl sulfate, and combinations thereof.

In certain embodiments, the composition comprises the anionic surfactant sodium dodecyl sulfate (SDS).

Suitable surfactants also include anionic surfactants selected from sulfosuccinate type anionic surfactants selected from the group consisting of sodium diisobutyl sulfosuccinate, dihexyl sodium sulfosuccinate, sodium diamyl sulfosuccinate, dicyclohexyl sulfosuccinate sodium salt, disodium 4-[2-[(1-oxoundec-10-enyl)amino]ethyl] 2-sulphonatosuccinate, and combinations thereof.

In various embodiments, the composition comprises the anionic surfactant sodium diisobutyl sulfosuccinate.

Suitable surfactants further include anionic surfactants selected from fatty acid salt type anionic surfactants selected from the group consisting of sodium stearate, magnesium stearate, potassium oleate, hydroxyaluminum distearate, and combinations thereof.

In certain embodiments, the composition comprises the anionic surfactant sodium stearate.

Other suitable anionic surfactants include organosilicon surfactants, fluorocarbon surfactants, fatty alcohol ammonium sulfates, soaps, and combinations thereof.

### Nonionic Surfactants

Suitable nonionic surfactants are selected from the group consisting of polyethylene glycol monooleyl ether, polyethylene glycol monocetyl ether, polyoxyethylene (20) sorbitan monolaurate (polysorbate 20), polyoxyethylene (40) sorbitan monolaurate (polysorbate 40), Tween 60, Tween 80, polyoxyethylene lauryl ether, sorbitan monostearate (Span 60), dibenzyl biphenyl polyoxyethylene ether, fatty alcohol polyoxyethylene ether, alky polyglucoside, lauryl polyglucoside, sorbitan sesquioleate, silicone polyethers, and combinations thereof.

For example, in various embodiments, the surfactant comprises a nonionic surfactant selected from the group consisting of polyethylene glycol monooleyl ether, polyoxyethylene (20) sorbitan monolaurate (polysorbate 20), sorbitan monostearate (Span 60), lauryl polyglucoside, and combinations thereof. In various embodiments, the composition comprises one of these individual surfactants as the surfactant component.

### Amphoteric Surfactants

Suitable amphoteric surfactants include those selected from the group consisting of lauryl betaine, sodium lauroamphoacetate, lauramidopropyl betaine, cocoamidopropyl betaine, coco alkyldimethyl betaine, and combinations thereof.

In various embodiments, the surfactant comprises an amphoteric surfactant selected from lauryl betaine, sodium lauroamphoacetate, cocoamidopropyl betaine, and combinations thereof.

### Corrosion Inhibitors

Optionally, the compositions of the present disclosure may include one or more corrosion inhibitors. Typically, the compositions of the present disclosure include one or more corrosion inhibitors.

When present, the one or more corrosion inhibitors generally are present in a concentration of at least about 0.1 wt %, at least about 0.2 wt %, at least about 0.3 wt %, at least about 0.4 wt %, or at least about 0.5 wt %. Typically, the one or more corrosion inhibitors are present in a concentration of less than about 1 wt %, less than about 0.8 wt %, less than about 0.6 wt %, or less than about 0.4 wt %.

For example, in various embodiments, the corrosion inhibitor(s) are present in a concentration of from about 0.1 wt % to about 0.6 wt %, or from about 0.2 wt % to about 0.4 wt %.

Concentrate compositions may include one or more corrosion inhibitors in a concentration of at least about 1 wt %, or from about 1 wt % to about 3 wt %.

Suitable corrosion inhibitors include molybdate corrosion inhibitors, including anhydrous sodium molybdate, its dihydrate, or mixtures thereof.

Other suitable corrosion inhibitors include azole corrosion inhibitors. For example, in certain embodiments, the azole corrosion inhibitor comprises tolytriazole and/or benzotriazole.

In some embodiments, the corrosion inhibitor can comprise a molybdate corrosion inhibitor and an azole corrosion inhibitor (e.g., sodium molybdate and tolytriazole).

In certain embodiments, the corrosion inhibitor system can optionally comprise one or more components such as sodium silicofluoride (SSF), sodium thiosulfate (STS), and dimercaptothiadiazole (DMTD). However, in certain embodiments, these corrosion inhibitor components are not required. In certain embodiments, the corrosion inhibitor system does not contain one or more of sodium silicofluoride (SSF), sodium thiosulfate (STS), and dimercaptothiadiazole (DMTD). Likewise, in certain embodiments, a solution produced from a fire-retardant concentrate composition described herein may or may not contain one or more of sodium silicofluoride (SSF), sodium thiosulfate (STS), and dimercaptothiadiazole (DMTD).

Other suitable corrosion inhibitors include calcium compounds selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

Additional suitable corrosion inhibitors include compounds selected from the group consisting of sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof.

### Thickeners

Optionally, the compositions of the present invention include one or more thickeners. Typically, the compositions of the present invention include one or more thickeners. Suitable thickeners include xanthan gum, rhamsan gum, velan gum, diutan gum, guar gum, and mixtures thereof.

In various embodiments, the thickener comprises, consists essentially of, or consists of xanthan gum.

Other suitable thickeners include carboxylate methylcellulose, hydroxyethyl cellulose, other cellulose ethers, and combinations thereof.

Where present, typically the one or more thickeners are present in a concentration of at least about 0.1 wt %, at least about 0.2 wt %, at least about 0.3 wt %, at least about 0.4 wt %, or at least about 0.5 wt %. In accordance with these and various other embodiments, the one or more thickeners may be present in a concentration of less than about 1 wt %, less than about 0.8 wt %, less than about 0.6 wt %, or less than about 0.4 wt %.

For example, in various embodiments, the thickener(s) are present in a concentration of from about 0.1 wt % to about 0.6 wt %, or from about 0.2 wt % to about 0.4 wt %.

In concentrate compositions, the one or more thickeners may be present in a concentration of at least about 1 wt %, or from about 1 wt % to about 3 wt %.

### Additional Components

Along with the above-noted components, the compositions also optionally include various other components. These may include flow conditioners, pigments (e.g., fugitive pigments), dyes, and opacifiers. Examples of such components are listed below.

### Flow Conditioners

Suitable flow conditioners include phosphate flow conditioners, oxide flow conditioners, silicate flow conditioners, silica flow conditioners, cellulose containing flow conditioners, and combinations thereof.

Where present, in various embodiments (e.g., fire retardant solutions), the flow conditioner is present in a concentration of at least about 0.01 wt %, from about 0.01 wt % to about 0.5 wt %, or from about 0.1 wt % to about 0.25 wt %. In concentrate compositions, the flow conditioner may be present in a concentration of from about 0.5 wt % to about 5.0 wt %, or from about 0.5 to about 3.0 wt %.

Suitable phosphate flow conditioners are selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof. In various embodiments, the phosphate flow conditioner is tricalcium phosphate.

Suitable oxide flow conditioners include magnesium oxide, sodium dioxide, calcium oxide, silicon dioxide, and combinations thereof. In various embodiments, the flow conditioner is magnesium oxide. In certain embodiments, the flow conditioner comprises silicon dioxide. Silica dioxide-containing flow conditioners include silicas such as untreated fumes silica and micronized silica. Options of commercially available sources of flow conditioner include the following silicon dioxide flow conditioners: ZEOFREE 80, 110SD, 200, 5161, 5162, 265, 5191, 5193, and 5170.

Suitable silicate flow conditioners may be selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof. In various embodiments, the silicate flow conditioner is selected from the group consisting of calcium silicate, aluminum silicate, sodium silicate, and combinations thereof. In various other embodiments, the flow conditioner is selected from sodium aluminosilicate, calcium silicate, aluminum silicate, and combinations thereof. Certain embodiments include calcium silicate as the flow conditioner. Options of commercially available calcium silicate flow conditioners include: HUBERSORB 5121, 250, and 600. Options of commercially available sodium aluminosilicate flow conditioners include: ZEOLEX 7, 201, 23A, and 7A.

Suitable cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof. In certain embodiments, the flow conditioner comprises ground rice hulls.

### (Fugitive) Pigments

Generally, the concentrates of the present invention may be uncolored, include a pigment (e.g., iron oxide), or be colored with a fugitive pigment.

In certain aspects, the pigment or dye comprises red iron oxide, brown iron oxide, or titanium dioxide.

Suitable color systems are described in, for example, U.S. Ser. No. 16/784,913 (US 2020/024290 A1) and U.S. Pat. No. 11,142,698, the entire contents of which are incorporated herein by reference for all relevant purposes.

In certain compositions, the dye or colorant may be present in a concentration of at least about 0.01 wt %, at least about 0.02 wt %, at least about 0.03 wt %, from about 0.01 wt % to about 0.1 wt %, or from about 0.01 wt % to about 0.05 wt %.

By way of further example, any dye or colorant may be present in a concentrate at a concentration from about 0.15 wt % to about 0.35 wt %, or from about 0.15 wt % to about 0.25 wt % of the concentrate. For example, iron oxide may be present in a concentration of from about 0.15 wt % to about 1.5 wt %, or from about 0.15 wt % to about 0.35 wt %.

In some embodiments, the pigment or dye can comprise a fugitive color system.

A fugitive color system may be present in a concentration of at least about 0.1 wt %, at least about 0.3 wt %, from about 0.1 wt % to about 1 wt %, or from about 0.2 wt % to about 0.8 wt %.

A fugitive color system may be present in a concentrate in a concentration of from about 1 wt % to about 3.5 wt %, from about 1.5 wt % to about 3.5 wt %, or from about 1.5 wt % to about 2.5 wt %.

For example, suitable fugitive pigment color systems include those described in U.S. Pat. No. 11,142,698, the entire contents of which are incorporated by reference herein for all relevant purposes.

Compositions of the present invention may also include other components such as opacifiers (e.g., zinc ferrite).

### Formulations

As noted above, compositions of the present invention may exhibit surface tension properties contributing to improved performance from improved diffusion throughout the fuel material of wildland fires. For example, it is currently believed the compositions of the present invention exhibit improved diffusion throughout wildland fire material, including throughout hydrophobic fuel material and/or loosely packed material. It is currently believed this improved performance may be provided and/or determined by the surface tension of the formulations, which are generally believed to be lower than other fire retardant formulations. For example, it is currently believed the surface tension of the present fire retardant formulations is lower than that of similar fire retardant formulations that do not include the surfactant(s) included in the present formulations and/or include the surfactant in a different manner (e.g., different concentrations and/or different proportions relative to the other components of the formulation).

In certain embodiments fire retardant formulations of the present invention (e.g., fire retardant solutions) may exhibit a surface tension of at least about 30 mN/m, at least about 35 mN/m, at least about 40 mN/m, at least about 45 mN/m, or at least about 50 mN/m. In these and various other embodiments, the surface tension may be less than about 100 mN/m, less than about 90 mN/m, less than about 80 mN/m, less than about 70 mN/m, less than about 60 mN/m, less than about 50 mN/m, less than about 40 mN/m, or less than about 30 mN/m.

For example, the surface tension of formulations of the present invention may be from about 30 mN/m to about 100 mN/m, from about 30 to about 80 mN/m, from about 35 mN/m to about 70 mN/m, or from about 35 mN/m or from about 60 mN/m.

Performance characteristics may also be used to identify improved diffusion of the formulation, along with or separate from the lower surface tension. For example, fire retardant formulations may be subjected to mass loss calorimeter testing (e.g., as described in Example 23) to identify the timing and manner of fuel mass loss and the timing of the fuel ignition and its heat release of combustion.

For example, as compared to a reference formulation (i.e., an identical formulation except in terms of surfactant identify and/or loading) the present formulations are currently believed to exhibit a delay in fuel mass loss that is at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% greater than that of the reference formulation.

For example, under the testing conditions of Example 23 this delay can be at least about 5 seconds (sec), at least about 10 sec, at least about 15 sec, or at least about 20 sec.

Additionally, or alternatively, the present formulations may exhibit a delay of the heat release peak in mass loss calorimeter testing that is at least about 5%, at least about 10%, at least about 15%, at least about 20%, at least about 25%, at least about 30%, at least about 35%, at least about 40%, at least about 45%, or at least about 50% of the heat release peak of the reference formulation.

For example, under the testing conditions of Example 23 this delay can be at least about 5 seconds (sec), at least about 10 sec, at least about 15 sec, or at least about 20 sec.

Fire retardant formulation may also be subjected to lab-scale burning test (e.g., as described in Example 24) to identify the retardant performance with regard to mass loss rate and flame spread rate of the treated fuel bed.

For example, as compared to a reference 10.6% DAP treatment, the present lower DAP concentration formulation reinforced with surfactant is believed to exhibit equivalent retardant burning in terms of similar mass loss rate and flame spread rate. The retardant loading can be reduced by at least about 1%, at least about 2%, at least about 5%, or at least about 10%.

In various embodiments, the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1.

In various other embodiments, the weight ratio of fire retardant component to surfactant is less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, or less than about 110:1.

In accordance with still further embodiments, the weight ratio of fire retardant component to surfactant is above one of the foregoing lower limits and below one of the foregoing upper limits.

In certain embodiments, the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

In other embodiments, the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, or less than about 4:1.

In accordance with still further embodiments, the weight ratio of the optional corrosion inhibitor(s) to surfactant is above one of the foregoing lower limits and below one of the foregoing upper limits.

By way of further example, the weight ratio of the one or more optional thickeners to surfactant maybe at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

In accordance with these and various other embodiments, the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, or less than about 4:1.

In accordance with still further embodiments, the weight ratio of optional thickener(s) to surfactant is above one of the foregoing lower limits and below one of the foregoing upper limits.

Further in accordance with the present disclosure, the fire retardant component may be present in a concentration of at least about 3 wt %, at least about 4 wt %, at least about 5 wt %, at least about 6 wt %, at least about 7 wt %, at least about 8 wt, at least about 9 wt %, or at least about 10 wt %. The fire retardant component may also be present in a concentration of less than about 20 wt %, less than about 18 wt %, less than about 16 wt %, less than about 14 wt %, less than about 12 wt %, or less than about 10 wt %.

In accordance with various embodiments, the fire retardant component may be present in a concentration that is above one of the listed lower limits and below one of the listed upper limits.

Further in accordance with the present disclosure, the surfactant may be present in a concentration of at least about 0.01 wt %, at least about 0.03 wt %, at least about 0.05 wt %, at least about 0.07 wt %, at least about 0.1 wt %, at least about 0.12 wt %, or at least about 0.15 wt %; or the surfactant may present in a concentration of less than about 1 wt %, less than about 0.75 wt %, less than about 0.5 wt %, less than about 0.25 wt %, or less than about 0.15 wt %.

The surfactant may further be present in a concentration above one of the listed lower limits and below one of the listed upper limits.

Also, in accordance with the present disclosure, the one or more optional corrosion inhibitors may be present in a concentration of at least about 0.1 wt %, at least about 0.2 wt %, at least about 0.3 wt %, at least about 0.4 wt %, or at least about 0.5 wt %.

The one or the one or more optional corrosion inhibitors may also be present in a concentration of less than about 1 wt %, less than about 0.8 wt %, less than about 0.6 wt %, or less than about 0.4 wt %.

Also, in accordance with the present disclosure, the optional corrosion inhibitor(s) may be present in a concentration above one of the listed lower limits and below one of the listed upper limits.

Further in accordance with the foregoing embodiments, one or more optional thickeners may be present in a concentration of at least about 0.1 wt %, at least about 0.2 wt %, at least about 0.3 wt %, at least about 0.4 wt %, or at least about 0.5 wt %.

The one or more optional thickeners may also be present in a concentration of less than about 1 wt %, less than about 0.8 wt %, less than about 0.6 wt %, or less than about 0.4 wt %.

Further, in accordance with the present disclosure, the optional corrosion inhibitor(s) may be present in a concentration above one of the listed lower limits and below one of the listed upper limits.

Water may be present in a concentration of at least about 75 wt %, least about 80 wt %, at least about 85 wt %, or at least about 90 wt %; and/or a concentration of less than about 95 wt %, less than about 92 wt %, or less than about 90 wt %.

Water may also be present in a concentration above one of the listed lower limits and below one of the listed upper limits.

In accordance with various embodiments of the present disclosure, concentrate compositions of the present invention satisfy one or mor of the following characteristics.

The weight ratio of fire retardant component to surfactant may be at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1.

The weight ratio of fire retardant component to surfactant may be less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, or less than about 110.

The weight ratio of the one or more optional corrosion inhibitors to surfactant may be at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

The weight ratio of the one or more optional corrosion inhibitors to surfactant may be less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, or less than about 4:1.

In accordance with various embodiments, the weight ratio may be above one of the listed lower limits and below one of the listed upper limits.

The weight ratio of the one or more optional thickeners to surfactant may be at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

The weight ratio of the one or more optional thickeners to surfactant may be less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, or less than about 4:1.

In accordance with various embodiments, the weight ratio may be above one of the listed lower limits and below one of the listed upper limits.

In various embodiments in accordance with the foregoing discussion, the fire retardant component comprises monoammonium phosphate (MAP) and/or diammonium phosphate (DAP), ammonium polyphosphate (APP), or phosphoric acid along with a non-phosphate fire retardant selected from the group consisting of potassium carbonate, potassium bicarbonate, sodium carbonate, sodium bicarbonate, ammonium carbonate, ammonium bicarbonate, magnesium chloride, magnesium sulfate, ammonium chloride, ammonium bromide, ammonium sulfate, urea, dicyandiamide, melamine, cyanamide, and combinations thereof.

### Fire Retardant Concentrates

Various aspects of the present invention involve fire retardant concentrates.

In certain aspects, the composition is in the form of a solid concentrate (e.g., dry concentrate, a powder concentrate, or a flowable powder concentrate).

Typically, in accordance with such embodiments, the at least one fire retardant is present in a concentration of at least about 75 wt %, at least about 80 wt %, at least about 85 wt %, at least about 90 wt %, at least about 95 wt %, or above any of these lower limits and up to about 95 wt %.

Aspects of the present invention are also directed to liquid fire retardant concentrates.

Typically, in accordance with such embodiments, the at least one fire retardant is present in a concentration of less than about 95 wt %, less than about 85 wt %, less than about 80 wt %, less than about 75 wt %, less than about 70 wt %, less than about 65 wt %, less than about 60 wt %, less than about 55 wt %, less than about 50 wt %, less than about 45 wt %, or less than about 40 wt %, or below any of these upper limits and above at least about 25 wt %. Additionally, or alternatively, water is typically present in a concentration of at least about 20 wt %, at least about 25 wt %, at least about 30 wt %, at least about 35 wt %, at least about 40 wt %, at least about 45 wt %, at least about 50 wt %, or above any of these lower limits and below at least about 60 wt %.

Further in accordance with the foregoing, the compositions of the present disclosure include one or more of the following components in the following concentrations, proportions, etc. and in accordance with the compositions defined in the appended claims.

As noted, fire retardant concentrates of the present invention may be in the form of solid (dry, e.g., powder) concentrates or liquid concentrates. Additionally, or alternatively, liquid concentrates may be prepared from solid concentrates by dilution with water. In this regard, it is to be understood that such liquid concentrates have not been diluted to such a level that would provide a fire retardant solution as discussed herein. Liquid concentrates may also be prepared by diluting the fire retardant(s) and other components included in the concentrate as described herein with water.

### Fire Retardant Solutions

Aspects of the present disclosure include fire retardant solutions prepared by mixing a fire-retardant concentrate composition, as described anywhere herein, with water to form an aqueous solution. Reference to a fire retardant formulation elsewhere herein may be understood to refer to a fire retardant solution as well. In certain embodiments, a homogenous solution is formed. In certain other embodiments, the water contains low levels of bacterial contamination that can impact viscosity and/or stability by consuming biopolymers. Thus, in certain embodiments, the water contains a biocide to prevent bacterial contamination. In certain embodiments, the solution comprises insoluble components.

In certain embodiments, the solution is prepared by combining at least 5 volumes of water per volume of liquid concentrate. In certain embodiments, the ratio of water to liquid concentrate is from about 5 volumes to about 7 volumes of water to about 1 volume of liquid concentrate.

In certain other embodiments, a solution of the present disclosure is prepared by combining at least about 0.5 pounds (lbs.), at least about 0.6 lbs., at least about 0.7 lbs., at least about 0.8 lbs., at least about 0.9 lbs., at least about 1.0 lb., at least about 1.5 lbs., or at least 2 lbs. of fire retardant concentrate per gallon of water.

In certain embodiments, a fire-retardant solution meets one or more of the required criteria developed by the appropriate regulatory authorities, including U.S. Department of Agriculture, Forest Service (USFS), Specification Number 5100-304d, January 2020, including any and all amendments and updates to this Specification and/or any other regulations or requirements developed by the USFS.

In certain embodiments, a fire-retardant solution meets one or more of the required criteria for corrosion and/or stability of the USFS (e.g., U.S. Department of Agriculture, Forest Service, Specification Number 5100-304d, January 2020, including all amendments).

In certain embodiments, a fire-retardant solution meets all of the required criteria for corrosion of the USFS (e.g., U.S. Department of Agriculture, Forest Service, Specification Number 5100-304d, January 2020, including all amendments).

For example, various embodiments of the present invention involve fire retardant solutions that may and typically or preferably meet one or more, or all of the metal corrosion standards established by the USFS (e.g., in USFS Specification 5100-304d (Jan. 7, 2020), entitled “Long-Term Retardant, Wildland Firefighting”). A wildland fire retardant solution can qualify for application for use with fixed tank helicopters when the maximum corrosion rates for 2024 T3 aluminum, 4130 steel, yellow brass and AZ-31-B magnesium are not higher than 2 milli-inch per year (MPY), 5 MPY, 5 MPY and 4 MPY, respectively. For qualification of use with fixed-wing air tankers, the maximum allowable corrosion rate of a wildland fire retardant solution to aluminum is 2 MPY, and maximum corrosion rates to steel and brass is 5 MPY while corrosion to magnesium is not required.

The present invention thus involves fire retardant solutions that may typically or preferably exhibit aluminum (e.g., 2024T3 aluminum) corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

Additionally, or alternatively, the present invention involves fire retardant solutions that may typically or preferably exhibit steel (e.g., 4130 steel) corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

The present invention also involves fire retardant solutions that may typically or preferably exhibit yellow brass corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

Further additionally or alternatively, the fire retardant solutions may typically or preferably exhibit magnesium (e.g., AZ-31-B magnesium) corrosion of 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

In certain embodiments, the present invention involves fire retardant compositions (e.g., fire retardant solutions and concentrates diluted to prepare fire retardant solutions) that may typically or preferably meet the applicable steel, yellow brass and magnesium corrosion standards. A pH regulating compound may be included, thereby providing a composition also meeting the applicable aluminum corrosion standards.

In certain embodiments, a fire-retardant solution meets all of the required criteria for stability of the USFS (e.g., U.S. Department of Agriculture, Forest Service, Specification Number 5100-304d, January 2020, including all amendments).

In certain embodiments, a fire-retardant solution meets all of the required criteria for corrosion and stability of the USFS (e.g., U.S. Department of Agriculture, Forest Service, Specification Number 5100-304d, January 2020, including all amendments).

In certain embodiments, a fire-retardant solution meets all of the required criteria of the USFS (e.g., U.S. Department of Agriculture, Forest Service, Specification Number 5100-304d, January 2020, including all amendments).

In certain embodiments, the fire-retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments.

The disclosed solutions also exhibit low aquatic toxicity. For example, in certain embodiments, a solution exhibits an aquatic toxicity (LC50) in the range of from about 180 milligrams per liter to about 1500 milligrams per liter. In certain embodiments, a solution exhibits an aquatic toxicity (LC50) greater than about 180, 200, 500, 1000, 2000, or 2500 milligrams per liter. In certain embodiments, a solution exhibits an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

In certain embodiments, a fire-retardant solution has a pH in the range of from about pH 4.0 or 5.0 to about pH 10.0. In certain embodiments, a fire-retardant solution has a pH in the range of from about pH 6.0 about pH 10.0. In certain embodiments, a fire-retardant solution has a pH in the range of from about pH 6.0 to about pH 10.0 (e.g., from about 6.0 to about 10.0 or from about 6.0 to about 9.5). In certain embodiments, a fire-retardant solution has a pH in the range of from about pH 9.0. to about pH 9.3. In certain embodiments, a fire-retardant solution has an alkaline pH.

In certain embodiments, visibility of the applied solution is improved, allowing firefighting forces to draw an effective chemical fire barrier using less total solution.

### Methods of Combatting a Wildfire

Disclosed herein are methods of combatting a wildfire by applying a fire-retardant solution described anywhere herein for the purpose of suppressing, containing, controlling, or extinguishing, etc., a wildfire. In certain embodiments, the fire-retardant solution is applied directly onto a flaming fuel. In other embodiments, the fire-retardant solution is applied indirectly, e.g., in front of or parallel to the moving fire front. The distance between the advancing fire and the retardant fire-break depends on the rate that the solution can be applied, the rate of spread of the moving fire front, and the presence or absence of a natural fuel break identified by changes in the geometry of the ground being threatened. In certain embodiments, the fire-retardant solution is applied from a ground platform such as a fire-engine. In these and certain other embodiments, the fire-retardant solution is applied from an aerial platform such as a fixed-wing aircraft or a rotary-wing aircraft. For example, in certain embodiments, the fire-retardant solution is applied from a rotary-wing aircraft such as a helicopter utilizing a bucket which is slung below the helicopter and in other embodiments the fire-retardant solution is contained within tanks mounted in or attached externally to the helicopter. In other embodiments, the fire retardant solution is applied from a mix of all of those listed vehicles or platforms. Obviously, the safety of the solution relative to aircraft corrosion and fouling of critical components must be greater when the solution is within or in contact with the aircraft.

In various other embodiments, the compositions are used for fire prevention by treating grounds, brush, etc. that may be susceptible to wildfires.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description shall be interpreted as illustrative and not in a limiting sense.

### EXAMPLES

The following non-limiting examples are provided to further illustrate the present invention.

### Example 1

A phosphate based liquid fire-retardant composition may be prepared with diammonium phosphate as the active fire retardant agent and anionic surfactant (e.g., sodium dodecylbenzene sulfonate) as wetting agent. The detailed formula is shown in Table 1. The as-prepared formulation may show surface tension value may be in the range of about 30 mN/m to about 50 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 1
Diluted liquid fire-retardant composition of Example 1

| | Weight percentage |
|---|---|
| | in fire retardant |
| Ingredient | composition (wt. %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (sodium dodecylbenzene | 0.01-0.1 |
| sulfonate) | |
| Total weight of fire-retardant | 100 |
| composition | |

### Example 2

A phosphate based liquid fire-retardant composition may be prepared with diammonium phosphate as the active fire retardant agent and anionic surfactant (e.g., sodium dodecylbenzene sulfonate) as wetting agent. The detailed formula is shown in Table 2. The as-prepared formulation may show surface tension value may be in the range of about 30 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 2
Liquid dilute formulation of Example 2

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (sodium dodecylbenze | 0.05-1 |
| sulfonate) | |
| Total | 100 |

### Example 3

A phosphate based liquid fire-retardant composition may be prepared with diammonium phosphate as the active fire retardant agent and anionic surfactant (e.g., sodium dodecyl sulfate) as wetting agent. The detailed formula is shown in Table 3. The as-prepared formulation may show surface tension value may be in the range of about 30 mN/m to about 50 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 3
Liquid dilute formulation of Example 3

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (sodium dodecyl sulfate) | 0.01-0.1 |
| Total | 100 |

### Example 4

A phosphate based liquid fire-retardant composition may be prepared with diammonium phosphate as the active fire retardant agent and anionic surfactant (e.g., sodium dodecyl sulfate) as wetting agent. The detailed formula is shown in Table 4. The as-prepared formulation may show surface tension value may be in the range of about 30 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 4
Liquid dilute formulation of Example 4

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-1 |
| phosphate | |
| Corrosion inhibitor | 0.1-1 |
| Surfactant (sodium dodecyl sulfate) | 0.05-1 |
| Total | 100 |

### Example 5

A phosphate based liquid fire-retardant composition may be prepared with diammonium phosphate as the active fire retardant agent and anionic surfactant (e.g., sodium diisobutyl sulfosuccinate) as wetting agent. The detailed formula is shown in Table 5. The as-prepared formulation may show surface tension value may be in the range of about 30 mN/m to about 50 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 5
Liquid dilute formulation of Example 5

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-1 |
| phosphate | |
| Corrosion inhibitor | 0.1-1 |
| Surfactant (sodium diisobutyl | 0.01-0.1 |
| sulfosuccinate) | |
| Total | 100 |

### Example 6

A phosphate based liquid fire-retardant composition may be prepared with diammonium phosphate as the active fire retardant agent and anionic surfactant (e.g., sodium diisobutyl sulfosuccinate) as wetting agent. The detailed formula is shown in Table 6. The as-prepared formulation may show surface tension value may be in the range of about 30 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 6
Liquid dilute formulation of Example 6

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-1 |
| phosphate | |
| Corrosion inhibitor | 0.1-1 |
| Surfactant (sodium diisobutyl | 0.05-0.5 |
| sulfosuccinate) | |
| Total | 100 |

### Example 7

A phosphate based liquid fire-retardant composition may be prepared with diammonium phosphate as the active fire retardant agent and anionic surfactant (e.g., sodium stearate) as wetting agent. The detailed formula is shown in Table 7. The as-prepared formulation may show surface tension value may be in the range of about 30 mN/m to about 50 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 7
Liquid dilute formulation of Example 7

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-1 |
| phosphate | |
| Corrosion inhibitor | 0.1-1 |
| Surfactant: e.g., sodium stearate | 0.01-0.1 |
| Total | 100 |

### Example 8

A phosphate based liquid fire-retardant composition may be prepared with diammonium phosphate as the active fire retardant agent and anionic surfactant (e.g., sodium stearate) as wetting agent. The detailed formula is shown in Table 8. The as-prepared formulation may show surface tension value may be in the range of about 30 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 8
Liquid dilute formulation of Example 7

| | Weight percentage of |
|---|---|
| | each ingredient in the |
| Ingredient | dilute formulation (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.2 |
| Flow conditioner: e.g., tricalcium | 0.1-0.5 |
| phosphate | |
| Corrosion inhibitor | 0.1-1 |
| Surfactant (sodium stearate) | 0.05-0.5 |
| Total | 100 |

### Example 9

A phosphate based liquid fire-retardant composition may be prepared with diammonium phosphate as the active fire retardant agent and nonionic surfactant (e.g., polyethylene glycol monooleyl ether) as wetting agent. The detailed formula is shown in Table 9. The as-prepared formulation may show surface tension value may be in the range of about 30 mN/m to about 45 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 9
Liquid dilute formulation of Example 9

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium phosphate | 0.1-0.5 |
| Corrosion inhibitor | 0.1-1 |
| Surfactant (polyethylene glycol monooleyl | 0.01-0.1 |
| ether) | |
| Total | 100 |

### Example 10

A phosphate based liquid fire-retardant composition may be prepared with diammonium phosphate as the active fire retardant agent and nonionic surfactant (e.g., polyethylene glycol monooleyl ether) as wetting agent. The detailed formula is shown in Table 10. The as-prepared formulation may show surface tension value may be in the range of about 30 mN/m to about 40 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 10
Liquid dilute formulation of Example 9

| | Weight percentage of each |
|---|---|
| | ingredient in the dilute |
| Ingredient | formulation |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium phosphate | 0.1-1 |
| Corrosion inhibitor | 0.1-1 |
| Surfactant (polyethylene glycol monooleyl | 0.01-0.2 |
| ether) | |
| Total | 100 |

### Example 11

A phosphate based liquid fire-retardant composition may be prepared with diammonium phosphate as the active fire retardant agent and nonionic surfactant (e.g., polysorbate 20) as wetting agent. The detailed formula is shown in Table 11. The as-prepared formulation may show surface tension value may be in the range of about 30 mN/m to about 45 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 11
Liquid dilute formulation of Example 11

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium phosphate | 0.1-0.5 |
| Corrosion inhibitor | 0.1-1 |
| Surfactant (polyethylene glycol monooleyl | 0.01-0.1 |
| ether) | |
| Total | 100 |

### Example 12

A phosphate based liquid fire-retardant composition may be prepared with diammonium phosphate as the active fire retardant agent and nonionic surfactant (e.g., polysorbate 20) as wetting agent. The detailed formula is shown in Table 12. The as-prepared formulation may show surface tension value may be in the range of about 30 mN/m to about 40 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 12
Liquid dilute formulation of Example 12

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium phosphate | 0.1-0.5 |
| Corrosion inhibitor | 0.1-1 |
| Surfactant (polyethylene glycol monooleyl | 0.01-0.25 |
| ether) | |
| Total | 100 |

### Example 13

A phosphate based liquid fire-retardant composition may be prepared with diammonium phosphate as the active fire retardant agent and nonionic surfactant (e.g., Span 60) as wetting agent. The detailed formula is shown in Table 13. The as-prepared formulation may show surface tension value may be in the range of about 30 mN/m to about 45 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 13
Liquid dilute formulation of Example 13

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant ([full name?] Span 60) | 0.01-0.1 |
| Total | 100 |

### Example 14

A phosphate based liquid fire-retardant composition may be prepared with diammonium phosphate as the active fire retardant agent and nonionic surfactant (e.g., Span 60) as wetting agent. The detailed formula is shown in Table 14. The as-prepared formulation may show surface tension value may be in the range of about 30 mN/m to about 40 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 14
Liquid dilute formulation of Example 14

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant ([full name?] Span 60) | 0.05-0.25 |
| Total | 100 |

### Example 15

A phosphate based liquid fire-retardant composition may be prepared with diammonium phosphate as the active fire retardant agent and nonionic surfactant (e.g., lauryl polyglucoside) as wetting agent. The detailed formula is shown in Table 15. The as-prepared formulation may show surface tension value may be in the range of about 30 mN/m to about 45 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 15
Liquid dilute formulation of Example 15

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (lauryl polyglucoside) | 0.01-0.1 |
| Total | 100 |

### Example 16

A phosphate based liquid fire-retardant composition may be prepared with diammonium phosphate as the active fire retardant agent and nonionic surfactant (e.g., lauryl polyglucoside) as wetting agent. The detailed formula is shown in Table 16. The as-prepared formulation may show surface tension value may be in the range of about 30 Mn/m to about 40 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 16
Liquid dilute formulation of Example 16

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (lauryl polyglucoside) | 0.05-0.25 |
| Total | 100 |

### Example 17

A phosphate based liquid fire-retardant composition may be prepared with diammonium phosphate as the active fire retardant agent and amphoteric surfactant (e.g., lauryl betaine) as wetting agent. The detailed formula is shown in Table 17. The as-prepared formulation may show surface tension value may be in the range of about 28 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 17
Liquid dilute formulation of Example 17

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (lauryl betaine) | 0.01-0.1 |
| Total | 100 |

### Example 18

A phosphate based liquid fire-retardant composition may be prepared with diammonium phosphate as the active fire retardant agent and amphoteric surfactant (e.g., lauryl betaine) as wetting agent. The detailed formula is shown in Table 18. The as-prepared formulation may show surface tension value may be in the range of about 28 mN/m to about 37 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 18
Liquid dilute formulation of Example 18

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (lauryl betaine) | 0.05-0.5 |
| Total | 100 |

### Example 19

A phosphate based liquid fire-retardant composition may be prepared with diammonium phosphate as the active fire retardant agent and amphoteric surfactant (e.g., sodium lauroamphoacetate) as wetting agent. The detailed formula is shown in Table 19. The as-prepared formulation may show surface tension value may be in the range of about 28 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 19
Liquid dilute formulation of Example 19

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.1-0.1 |
| Flow conditioner: e.g., tricalcium | 0.1-0.5 |
| phosphate | |
| Corrosion inhibitor | 0.1-1 |
| Surfactant (sodium | 0.01-0.1 |
| lauroamphoacetate) | |
| Total | 100 |

### Example 20

A phosphate based liquid fire-retardant composition may be prepared with diammonium phosphate as the active fire retardant agent and amphoteric surfactant (e.g., sodium lauroamphoacetate) as wetting agent. The detailed formula is shown in Table 20. The as-prepared formulation may show surface tension value may be in the range of about 28 mN/m to about 37 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 20
Liquid dilute formulation of Example 20

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (sodium | 0.05-1 |
| lauroamphoacetate) | |
| Total | 100 |

### Example 21

A phosphate based liquid fire-retardant composition may be prepared with diammonium phosphate as the active fire retardant agent and amphoteric surfactant (e.g., cocoamidopropyl betaine) as wetting agent. The detailed formula is shown in Table 21. The as-prepared formulation may show surface tension value may be in the range of about 28 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 21
Liquid dilute formulation of Example 21

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment: e.g., fugitive | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (cocoamidopropyl betaine) | 0.01-0.1 |
| Total | 100 |

### Example 22

A phosphate based liquid fire-retardant composition may be prepared with diammonium phosphate as the active fire retardant agent and amphoteric surfactant (e.g., cocoamidopropyl betaine) as wetting agent. The detailed formula is shown in Table 22. The as-prepared formulation may show surface tension value may be in the range of about 28 mN/m to about 43 mN/m. The specific gravity of as-prepared formulation may be in the range of about 1.03 g/ml to about 1.11 g/ml. The pH of the as-prepared formulation may be in the range of about 6.5 to about 8.0. The viscosity of the as-prepared formulation may be in the range of about 150 cP to about 350 cP. The refractive index of the as-prepared formulation may be in the range of about 10 to about 12.

TABLE 22
Liquid dilute formulation of Example 22

| | Weight percentage of each |
|---|---|
| | ingredient in the dilute |
| | formulation |
| Ingredient | (wt %) |
| Water | 85-95 |
| DAP | 4-14 |
| Thickener: e.g., xanthan gum | 0.1-1 |
| Fugitive pigment | 0.1-1 |
| Pigment: e.g., iron oxide | 0.01-0.1 |
| Flow conditioner: e.g., tricalcium | 0.1-0.5 |
| phosphate | |
| Corrosion inhibitor | 0.1-1 |
| Surfactant (cocoamidopropyl betaine) | 0.05-0.25 |
| Total | 100 |

### Example 23

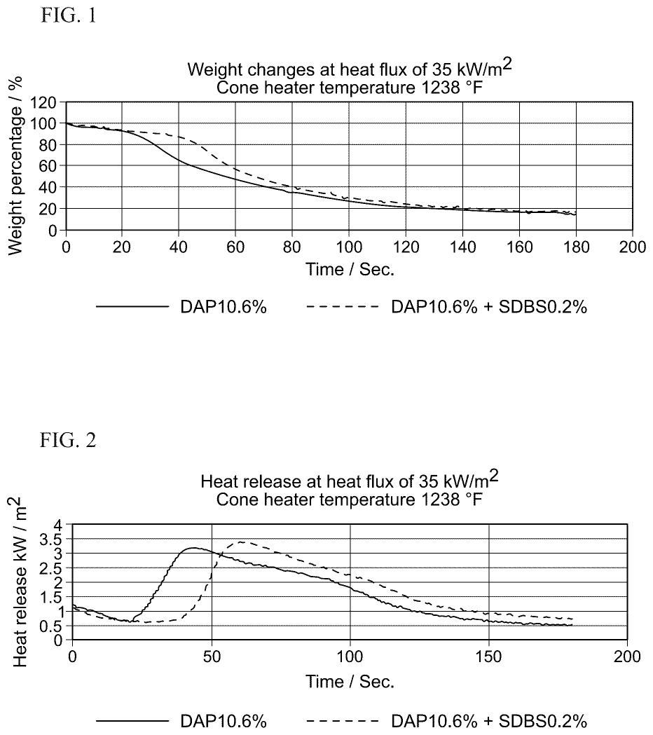

Wood excelsior beds were treated with fire retardant formulation with and without addition of anionic surfactant sodium dodecylbenzene sulfonate (SDBS) as wetting agent, as shown in Table 23. Diammonium phosphate (DAP) was used as fire retardant agent in the formulation solutions. The same levels of xanthan and fugitive pigment were added into the fire retardant solutions to visually show distribution of retardant on and through the excelsior beds. The fire retardant liquid with addition of wetting agent gets more uniform distribution on the excelsior bed surface than that of the control formulation without addition of wetting agent. The treated wood excelsior samples were also subjected to mass loss calorimeter test as shown in FIGS. 1 and 2. The results show that the wetting agent-assisted retardant formulation leads to a delay of significant weight loss when compared to the control sample. For the control sample, significant mass loss started at around 20 seconds, while at around 40 seconds the wetting agent assisted retardant treated sample began larger mass loss. The start of significant mass loss corresponds to the ignition/combustion of testing samples. Accordingly, there is also a delay of the heat release peak, which is due to the combustion of the sample. The test results suggest that the wetting agent-assisted retardant solution is able to delay the ignition and flame spread, improving the fire retardant performance.

TABLE 23

| | Control | S-DAP |
|---|---|---|
| Ingredient | wt % | wt % |
| Water | 88.76 | 88.56 |
| DAP | 10.6 | 10.6 |
| Thickener (xanthan gum) | 0.32 | 0.32 |
| Pigment (Fugitive ECO21) | 0.32 | 0.32 |
| Surfactant (sodium dodecylbenzene sulfonate) | | 0.2 |

Visual observations have been performed on wood excelsior bed surfaces for the control (10.6% DAP) and S-DAP (10.6% DAP+0.2% surfactant samples). Greater distribution of the fire retardant throughout the bed surfaces for the S-DAP sample was observed (e.g., thicker and more uniform coloring of the top bed surface from the presence of the retardant composition for the S-DAP composition). These results are shown in FIG. 1 of underlying U.S. Provisional Patent Application Ser. No. 63/719,223, the entire contents of which are incorporated herein by reference.

### Example 24

Phosphate based liquid fire-retardant compositions may be prepared with diammonium phosphate (DAP) as the active fire retardant agent and an amphoteric surfactant (e.g., lauryl betaine) as wetting agent. The solutions may contain DAP at concentrations of 10.07%, 9.54%, and 9.01%, while the concentration of lauryl betaine is 0.1%. Approximately 2 gallons of each solution may be applied over a surface approximately 100 square feet and having a bulk density of approximately 1.33 lb/ft³ wood excelsior fuel bed. As a comparison, standard 10.6% diammonium phosphate solution without surfactant loading may be prepared and applied to treat the same wood excelsior fuel bed. Burn tests may be conducted with the fuel beds treated by different retardant solutions. The wetting agent reinforced solutions with lower DAP concentrations may show similar retardant performance in terms of mass loss rate and flame spread rate, when compared to the standard reference of 10.6% DAP solution.

The 10.07%, 9.54%, and 9.01% wetting agent reinforced solutions contain DAP loadings equivalent to 95%, 90%, and 85%, respectively, of the loading of the 10.6% solution and are currently believed to achieve at least or near equivalent fire retardant performance as compared to the standard reference 10.6% DAP solution. Accordingly, these wetting agent reinforced solutions can be characterized as achieving at least about 5%, at least about 10%, at least about 15%, or even higher, retardant performance on a unit fire retardant (DAP) loading basis as compared to the standard reference of 10.6% DAP solution.

### EMBODIMENTS

For additional illustration, further and preferred embodiments of the present invention are set forth below.

Embodiment 1 is directed to a liquid fire retardant composition, the composition comprising: a fire retardant component comprising, consisting essentially of, or consisting of monoammonium phosphate (MAP), diammonium phosphate (DAP), ammonium polyphosphate (APP), phosphoric acid, and combinations thereof, or a fire retardant component comprising consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, or a combination thereof; a surfactant selected from anionic surfactants, nonionic surfactants, and amphoteric surfactants, and combinations thereof; optionally one or more corrosion inhibitors; optionally one or more thickeners; and water, wherein the composition satisfies one or more of the following: the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1; the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the surface tension of the composition is at least about 30 mN/m, at least about 35 mN/m, at least about 40 mN/m, at least about 45 mN/m, or at least about 50 mN/m.

Embodiment 2 is the composition of Embodiment 1, wherein the composition satisfies one or more of the following: the weight ratio of fire retardant component to surfactant is less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, less than about 110:1; the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and the surface tension of the composition is at less than about 100 mN/m, less than about 90 mN/m, less than about 80 mN/m, less than about 70 mN/m, less than about 60 mN/m, less than about 50 mN/m, less than about 40 mN/m, or less than about 30 mN/m.

Embodiment 3 is directed to a liquid fire retardant composition, the composition comprising: a fire retardant component comprising, consisting essentially of, or consisting of a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9 or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; a surfactant selected from anionic surfactants, nonionic surfactants, and amphoteric surfactants, and combinations thereof; one or more optional corrosion inhibitors; water; and one or more optional thickeners; wherein the composition satisfies one or more of the following: the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the surface tension of the composition is at least about 30 mN/m, at least about 35 mN/m, at least about 40 mN/m, at least about 45 mN/m, or at least about 50 mN/m.

Embodiment 4 is the composition of Embodiment 3, wherein the composition satisfies one or more of the following: the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and the surface tension of the composition is at less than about 100 mN/m, less than about 90 mN/m, less than about 80 mN/m, less than about 70 mN/m, less than about 60 mN/m, less than about 50 mN/m, less than about 40 mN/m, or less than about 30 mN/m.

Embodiment 5 is liquid fire retardant composition of any of Embodiments 1 to 4, wherein the composition satisfies one or more of the following: the fire retardant component is present in a concentration of at least about 3 wt %, at least about 4 wt %, at least about 5 wt %, at least about 6 wt %, at least about 7 wt %, at least about 8 wt, at least about 9 wt %, or at least about 10 wt %; the surfactant is present in a concentration of at least about 0.01 wt %, at least about 0.03 wt %, at least about 0.05 wt %, at least about 0.07 wt %, at least about 0.1 wt %, at least about 0.12 wt %, or at least about 0.15 wt %; the one or more optional corrosion inhibitors are present in a concentration of at least about 0.1 wt %, at least about 0.2 wt %, at least about 0.3 wt %, at least about 0.4 wt %, or at least about 0.5 wt %; the one or more optional thickeners are present in a concentration of at least about 0.1 wt %, at least about 0.2 wt %, at least about 0.3 wt %, at least about 0.4 wt %, or at least about 0.5 wt %; and water is present in a concentration of at least about 75 wt %, least about 80 wt %, at least about 85 wt %, or at least about 90 wt %.

Embodiment 6 is the liquid fire retardant composition of any of Embodiments 1 to 5, wherein the composition satisfies one or more of the following: the fire retardant component is present in a concentration of less than about 20 wt %, less than about 18 wt %, less than about 16 wt %, less than about 14 wt %, less than about 12 wt %, or less than about 10 wt %; the surfactant is present in a concentration of less than about 1 wt %, less than about 0.75 wt %, less than about 0.5 wt %, less than about 0.25 wt %, or less than about 0.15 wt %; the one or more optional corrosion inhibitors are present in a concentration of less than about 1 wt %, less than about 0.8 wt %, less than about 0.6 wt %, or less than about 0.4 wt %; the one or more optional thickeners are present in a concentration of less than about 1 wt %, less than about 0.8 wt %, less than about 0.6 wt %, or less than about 0.4 wt %; and water is present in a concentration of less than about 95 wt %, less than about 92 wt %, or less than about 90 wt %.

Embodiment 7 is directed to a fire retardant concentrate composition, the composition comprising: a fire retardant component comprising, consisting essentially of, or consisting of monoammonium phosphate (MAP), diammonium phosphate (DAP), ammonium polyphosphate (APP), and combinations thereof or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %; one or more optional corrosion inhibitors, wherein the one or more optional corrosion inhibitors are present in a concentration of at least about 1 wt %, or from about 1 wt to about 3 wt %; and one or more optional thickeners, wherein the one or more optional thickeners are present in a concentration of at least about 1 wt %, or from about 1 wt % to about 3 wt %; wherein the composition satisfies one or more of the following: the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1; the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

Embodiment 8 is the composition of Embodiment 7, wherein the composition satisfies one or more of the following conditions: the weight ratio of fire retardant component to surfactant is less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, less than about 110; the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1.

Embodiment 9 is directed to a fire retardant concentrate composition, the composition comprising: a fire retardant component comprising, consisting essentially of, or consisting of a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9 or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %; one or more optional corrosion inhibitors, wherein the one or more optional corrosion inhibitors are present in a concentration of at least about 1 wt %, or from about 1 wt to about 3 wt %; and one or more optional thickeners, wherein the one or more optional thickeners are present in a concentration of at least about 1 wt %, or from about 1 wt % to about 3 wt %; wherein the composition satisfies one or more of the following: the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

Embodiment 10 is directed to the composition of Embodiment 8 or Embodiment 9, wherein the composition satisfies one or more of the following: the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1.

Embodiment 11 is directed to the fire retardant composition of any of Embodiments 1 to 10 wherein the fire retardant component comprises monoammonium phosphate (MAP) and/or diammonium phosphate (DAP).

Embodiment 12 is directed to the fire retardant composition of any of Embodiments 1 to 10, wherein the fire retardant component comprises ammonium polyphosphate (APP).

Embodiment 13 is directed to the fire retardant composition of any of Embodiments 1 to 10, wherein the fire retardant component comprises phosphoric acid.

Embodiment 14 is directed to the fire retardant composition of any of Embodiments 1 to 13, wherein the fire retardant component comprises a non-phosphate fire retardant selected from the group consisting of potassium carbonate, potassium bicarbonate, sodium carbonate, sodium bicarbonate, ammonium carbonate, ammonium bicarbonate, magnesium chloride, magnesium sulfate, ammonium chloride, ammonium bromide, ammonium sulfate, urea, dicyandiamide, melamine, cyanamide, and combinations thereof.

Embodiment 15 is directed to the composition of any of Embodiments 1 to 14, wherein the surfactant comprises an anionic surfactant selected from sulfonate type anionic surfactants selected from the group consisting of sodium pentanesulfonate, butylnaphtalenesulfonic acid sodium salt, sodium 1-butanesulfonate, lignofulonic acid calcium salt, sodium dodecylbenzene sulfonate, sodium allylsulfonate, sodium lignosulfonate, calcium dodecylbenzene sulfonate, 2-dodecylbenzenesulfonate, sodium alkylbenzene sulfonate, disodium methylenebisnaphthalenesulfphonate, ammonium dodecylbenzenesulphonate, linear alklybenzene sulfonates, and combinations thereof.

Embodiment 16 is directed to the composition of Embodiment 15 wherein the surfactant comprises sodium dodecylbenzene sulfonate (SDBS) (anionic).

Embodiment 17 is directed to the composition of any of Embodiments 1 to 16, wherein the surfactant comprises an anionic surfactant selected from sulfate type anionic surfactants selected from the group consisting of lithium dodecyl sulfate, sodium octyl sulfate, sodium dodecyl sulfate, sodium decyl sulfate, ammonium layryl sulfate, sodium lauryl polyoxyethylene ether sulfate, sodium lauryl sulfate, and combinations thereof.

Embodiment 18 is directed to the composition of Embodiment 17, wherein the anionic surfactant comprises sodium dodecyl sulfate (SDS) (anionic).

Embodiment 19 is directed to the composition of any of Embodiments 1 to 18, wherein the surfactant comprises an anionic surfactant selected from sulfosuccinate type anionic surfactants selected from the group consisting of sodium diisobutyl sulfosuccinate, dihexyl sodium sulfosuccinate, sodium diamyl sulfosuccinate, dicyclohexyl sulfosuccinate sodium salt, disodium 4-[2-[(1-oxoundec-10-enyl)amino]ethyl] 2-sulphonatosuccinate, and combinations thereof; and/or

Embodiment 20 is directed to the composition of Embodiment 19, wherein the anionic surfactant comprises sodium diisobutyl sulfosuccinate (anionic).

Embodiment 21 is directed to the composition of any of Embodiments 1 to 20, wherein the surfactant comprises an anionic surfactant selected from fatty acid salt type anionic surfactants selected from the group consisting of sodium stearate, magnesium stearate, potassium oleate, hydroxyaluminum distearate, and combinations thereof.

Embodiment 22 is directed to the composition of Embodiment 21, wherein the anionic surfactant comprises sodium stearate (anionic).

Embodiment 23 is directed to the composition of any of Embodiments 1 to 22, wherein the surfactant comprises an anionic surfactant selected from organosilicon surfactants, fluorocarbon surfactants, fatty alcohol ammonium sulfates, soaps, and combinations thereof.

Embodiment 24 is directed to the composition of any of Embodiments 1 to 23, wherein the surfactant comprises a nonionic surfactant selected from the group consisting of polyethylene glycol monooleyl ether, polyethylene glycol monocetyl ether, polyoxyethylene (20) sorbitan monolaurate (polysorbate 20), polyoxyethylene (40) sorbitan monolaurate (polysorbate 40), Tween 60, Tween 80, polyoxyethylene lauryl ether, sorbitan monostearate (Span 60), dibenzyl biphenyl polyoxyethylene ether, fatty alcohol polyoxyethylene ether, alky polyglucoside, lauryl polyglucoside, sorbitan sesquioleate, silicone polyethers, and combinations thereof.

Embodiment 25 is directed to the composition of Embodiment 24, wherein the surfactant comprises a nonionic surfactant selected from the group consisting of polyethylene glycol monooleyl ether, polyoxyethylene (20) sorbitan monolaurate (polysorbate 20), sorbitan monostearate (Span 60), lauryl polyglucoside, and combinations thereof.

Embodiment 26 is directed to the composition of any of Embodiments 1 to 25, wherein the surfactant comprises an amphoteric surfactant selected from lauryl betaine, sodium lauroamphoacetate, lauramidopropyl betaine, cocoamidopropyl betaine, coco alkyldimethyl betaine, and combinations thereof.

Embodiment 27 is directed to the composition of Embodiment 26, wherein the surfactant comprises an amphoteric surfactant selected from lauryl betaine, sodium lauroamphoacetate, cocoamidopropyl betaine, and combinations thereof.

Embodiment 28 is directed to the composition of any of Embodiments 1 to 27, wherein the one or more thickeners are selected from the group consisting of xanthan gum, rhamsan gum, velan gum, diutan gum, guar gum, carboxylate methylcellulose, hydroxyethyl cellulose, and combinations thereof.

Embodiment 29 is directed to the composition of any of Embodiments 1 to 28, wherein the one or more optional corrosion inhibitors are selected from the group consisting of alkali metal phosphates, soluble calcium compounds, soluble magnesium salts, fatty acids, sodium salts of fatty acids, aliphatic carboxylates, aromatic carboxylates, molybdate corrosion inhibitors, azole corrosion inhibitors, and combinations thereof.

Embodiment 30 is directed to the composition of Embodiment 29 wherein the one or more corrosion inhibitors comprise a molybdate corrosion inhibitor selected from sodium molybdate.

Embodiment 31 is directed to the composition of Embodiment 29 wherein the one or more corrosion inhibitors comprises an azole corrosion inhibitor selected from tolytriazole, 2-mercaptobenzothiazole, benzotriazole, dimercaptobenzothiazole, and combinations thereof.

Embodiment 32 is directed to a liquid fire retardant composition, the composition comprising: a fire retardant component comprising, consisting essentially of, or consisting of a phosphate fire retardant or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof, wherein the fire retardant component constitutes at least about 85 wt % of the composition; a surfactant selected from anionic surfactants, nonionic surfactants, and amphoteric surfactants, and combinations thereof, wherein the surfactant constitutes from about 0.01 wt % to about 1 wt % of the composition; one or more optional corrosion inhibitors, wherein the weight ratio of the surfactant to the one or more optional corrosion inhibitors is from 0.01:1 to 1:1; one or more optional pigments, wherein the weight ratio of the surfactant to the one or more optional pigments is from 0.01:1 to 1:1; and one or more optional thickeners, wherein the weight ratio of the surfactant to the one or more optional pigments is from 0.01:1 to 1:1, wherein: the liquid fire retardant composition has a surface tension that varies no more than 50% from the surface tension of water.

Embodiment 33 is directed to a liquid fire retardant composition, the composition comprising: a fire retardant component comprising a phosphate fire retardant and a non-phosphate fire retardant, wherein the phosphate fire retardant constitutes at least about 50 wt % of the fire retardant component and the non-phosphate fire retardant comprises, consists essentially of, or consists of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, or a combination thereof; a surfactant selected from anionic surfactants, nonionic surfactants, and amphoteric surfactants; and one or more optional components selected from corrosion inhibitors, pigments, thickeners, and combinations thereof, wherein: the phosphate fire retardant comprises monoammonium phosphate (MAP), diammonium phosphate (DAP), ammonium polyphosphate (APP), phosphoric acid or a combination thereof; the surfactant constitutes from about 0.01 wt % to about 1.0 wt % or from about 0.01 wt % to about 0.5 wt %; and the liquid fire retardant composition has a surface tension that varies no more than 50% from the surface tension of water.

Embodiment 34 is directed to a liquid fire retardant composition, the composition comprising: a fire retardant component comprising a phosphate fire retardant, wherein the phosphate fire retardant constitutes at least about 50 wt % of the fire retardant component or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; an anionic surfactant, wherein the anionic surfactant constitutes from about 0.01 wt % to about 1 wt % of the composition; and one or more optional components selected from corrosion inhibitors, pigments, thickeners, and combinations thereof, wherein: the liquid fire retardant composition has a surface tension that varies no more than 50% from the surface tension of water; and the anionic surfactant is selected from sulfonate type anionic surfactants selected from the group consisting of sodium pentanesulfonate, butylnaphtalenesulfonic acid sodium salt, sodium 1-butanesulfonate, lignofulonic acid calcium salt, sodium dodecylbenzene sulfonate, sodium allylsulfonate, sodium lignosulfonate, calcium dodecylbenzene sulfonate, 2-dodecylbenzenesulfonate, sodium alkylbenzene sulfonate, disodium methylenebisnaphthalenesulfphonate, ammonium dodecylbenzenesulphonate, linear alklybenzene sulfonates, and combinations thereof, and/or the anionic surfactant is selected from sulfate type anionic surfactants selected from the group consisting of lithium dodecyl sulfate, sodium octyl sulfate, sodium dodecyl sulfate, sodium decyl sulfate, ammonium layryl sulfate, sodium lauryl polyoxyethylene ether sulfate, sodium lauryl sulfate, and combinations thereof; and/or the anionic surfactant is selected from sulfosuccinate type anionic surfactants selected from the group consisting of sodium diisobutyl sulfosuccinate, dihexyl sodium sulfosuccinate, sodium diamyl sulfosuccinate, dicyclohexyl sulfosuccinate sodium salt, disodium 4-[2-[(1-oxoundec-10-enyl)amino]ethyl] 2-sulphonatosuccinate, and combinations thereof; and/or the anionic surfactant is selected from fatty acid salt type anionic surfactants selected from the group consisting of sodium stearate, magnesium stearate, potassium oleate, hydroxyaluminum distearate, and combinations thereof; and/or the anionic surfactant is selected from other types selected from of anionic surfactants comprising of organosilicon surfactant, fluorocarbon surfactant, fatty alcohol ammonium sulfate, soaps, and combinations thereof.

Embodiment 35 is directed to a liquid fire retardant composition, the composition comprising: a fire retardant component comprising a phosphate fire retardant, wherein the phosphate fire retardant constitutes at least about 50 wt % of the fire retardant component or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; a nonionic surfactant, wherein the nonionic surfactant constitutes from about 0.01 wt % to about 1 wt % of the composition; and one or more optional components selected from corrosion inhibitors, pigments, thickeners, and combinations thereof, wherein: the liquid fire retardant composition has a surface tension that varies no more than 50% from the surface tension of water; and the nonionic surfactant is selected from polyethylene glycol monooleyl ether, polyethylene glycol monocetyl ether, polysorbate 20, polysorbate 40, Tween 60, Tween 80, polyoxyethylene lauryl ether, Span 60, dibenzyl biphenyl polyoxyethylene ether, fatty alcohol polyoxyethylene ether, alky polyglucoside, lauryl polyglucoside, sorbitan sesquioleate, silicone polyethers, and combinations thereof.

Embodiment 36 is directed to a liquid fire retardant composition, the composition comprising: a fire retardant component comprising a phosphate fire retardant, wherein the phosphate fire retardant constitutes at least about 50 wt % of the fire retardant component or a fire retardant component comprising, consisting essentially of, or consisting of an alkali metal carbonate salt selected from the group consisting of potassium carbonate, potassium bicarbonate, sodium carbonate, sodium bicarbonate, lithium carbonate, ammonia carbonate, ammonia bicarbonate and combinations thereof; a magnesium chloride fire retardant selected from MgCl₂ and magnesium chloride hydrates (MgCl₂·(H₂O)ₓ, where x is 1, 2, 4, 6, 8, or 12); magnesium sulfate fire retardants selected from MgSO₄ magnesium sulfate hydrates (MgSO₄·(H₂O)ₓ, where x is 1, 2, 3, 4, 5, 6, 7, 9, 10 or 11); ammonium chloride, ammonium bromide, ammonium sulfate, urea, dicyandiamide, melamine, cyanamide, and/or a combination thereof; an amphoteric surfactant, wherein the amphoteric surfactant constitutes from about 0.01 wt % to about 1 wt % of the composition; and one or more optional components selected from corrosion inhibitors, pigments, thickeners, and combinations thereof, wherein: the liquid fire retardant composition has a surface tension that varies no more than 50% from the surface tension of water; and the amphoteric surfactant is selected from lauryl betaine, sodium lauroamphoacetate, lauramidopropyl betaine, cocoamidopropyl betaine, coco alkyldimethyl betaine, and combinations thereof.

Embodiment 37 is directed to the composition of any of Embodiment 32 to 36, wherein the optional corrosion inhibitors are selected from alkali metal phosphates, soluble calcium compounds, soluble magnesium salts, fatty acids, sodium salts of fatty acids, aliphatic carboxylates, aromatic carboxylates, sodium molybdate, tolytriazole, 2-mercaptobenzothiazole, benzotriazole, dimercaptobenzothiazole, or a combination of thereof.

Embodiment 38 is directed to the composition of any of Embodiments 32 to 37, wherein the optional thickener is selected from the group of biopolymers, including, xanthan gum, carboxylate methylcellulose, hydroxyethyl cellulose, other cellulose ethers or a combination of thereof.

Embodiment 39 is directed to the composition of any of Embodiments 32 to 38, wherein the optional pigment is selected from a fugitive pigment, an opacifier, or a combination thereof.

Embodiment 40 is directed to the composition of any of Embodiments 32 to 39, wherein the composition optionally further comprises a suspending agent selected from mineral clay, kaolin, and combinations thereof.

1. A liquid fire retardant composition, the composition comprising:
a fire retardant component comprising monoammonium phosphate (MAP), diammonium phosphate (DAP), ammonium polyphosphate (APP), phosphoric acid, and combinations thereof;
a surfactant selected from anionic surfactants, nonionic surfactants, and amphoteric surfactants, and combinations thereof;
optionally, one or more corrosion inhibitors;
optionally, one or more thickeners; and
water, wherein the composition satisfies one or more of the following:
the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1;
the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1;
the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and
the surface tension of the composition is at least about 30 mN/m, at least about 35 mN/m, at least about 40 mN/m, at least about 45 mN/m, or at least about 50 mN/m.

2. The composition of claim 1, wherein the composition satisfies one or more of the following:
the weight ratio of fire retardant component to surfactant is less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, less than about 110:1:
the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1;
the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and
the surface tension of the composition is at less than about 100 mN/m, less than about 90 mN/m, less than about 80 mN/m, less than about 70 mN/m, less than about 60 mN/m, less than about 50 mN/m, less than about 40 mN/m, or less than about 30 mN/m.

3. A liquid fire retardant composition, the composition comprising:
a fire retardant component comprising a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9;
a surfactant selected from anionic surfactants, nonionic surfactants, and amphoteric surfactants, and combinations thereof;
optionally, one or more corrosion inhibitors;
water; and
optionally, one or more thickeners; wherein the composition satisfies one or more of the following:
the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1;
the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and
the surface tension of the composition is at least about 30 mN/m, at least about 35 mN/m, at least about 40 mN/m, at least about 45 mN/m, or at least about 50 mN/m.

4. The composition of claim 3, wherein the composition satisfies one or more of the following:
the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1;
the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and
the surface tension of the composition is at less than about 100 mN/m, less than about 90 mN/m, less than about 80 mN/m, less than about 70 mN/m, less than about 60 mN/m, less than about 50 mN/m, less than about 40 mN/m, or less than about 30 mN/m.

5. (canceled)

6. (canceled)

7. A fire retardant concentrate composition, the composition comprising:
a fire retardant component comprising monoammonium phosphate (MAP), diammonium phosphate (DAP), ammonium polyphosphate (APP), and combinations thereof;
a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %;
one or more optional corrosion inhibitors, wherein the one or more corrosion inhibitors are present in a concentration of at least about 1 wt %, or from about 1 wt to about 3 wt %; and
one or more optional thickeners, wherein the one or more thickeners are present in a concentration of at least about 1 wt %, or from about 1 wt % to about 3 wt %; wherein the composition satisfies one or more of the following:
the weight ratio of fire retardant component to surfactant is at least about 50:1, at least about 60:1, at least about 70:1, at least about 80:1, at least about 90:1, at least about 100:1, at least about 110:1, at least about 120:1, at least about 130:1, at least about 140:1, at least about 150:1, at least about 160:1, at least about 170:1, at least about 180:1, at least about 190:1, at least about 200:1, at least about 210:1, at least about 220:1, at least about 230:1, at least about 240:1, or at least about 250:1;
the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and
the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

8. The composition of claim 7, wherein the composition satisfies one or more of the following conditions:
the weight ratio of fire retardant component to surfactant is less than about 260:1, less than about 250:1, less than about 240:1, less than about 230:1, less than about 220:1, less than about 210:1, less than about 200:1, less than about 190:1, less than about 180:1, less than about 170:1, less than about 160:1, less than about 150:1, less than about 140:1, less than about 130:1, less than about 120:1, less than about 110:
the weight ratio of the one or more optional corrosion inhibitors to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1; and
the weight ratio of the one or more optional thickeners to surfactant is less than about 10:1, less than about 9.5:1, less than about 9:1, less than about 8.5:1, less than about 8:1, less than about 7.5:1, less than about 7:1, less than about 6.5:1, less than about 6:1, less than about 5.5:1, less than about 5:1, less than about 4.5:1, less than about 4:1.

9. A fire retardant concentrate composition, the composition comprising:
a fire retardant component comprising a mixture of monoammonium phosphate (MAP) and diammonium phosphate (DAP), wherein the mixture of MAP and DAP exhibits a molar ratio of ammoniacal nitrogen to phosphorus (N/P ratio) of from about 1.1 to about 1.9;
a surfactant selected from anionic surfactants, nonionic surfactants, and amphoteric surfactants, and combinations thereof, wherein the surfactant is present in a concentration of at least about 0.5 wt %, or from about 0.5 wt % to about 1.5 wt %;
one or more optional corrosion inhibitors, wherein the one or more corrosion inhibitors are present in a concentration of at least about 1 wt %, or from about 1 wt to about 3 wt %; and
one or more optional thickeners, wherein the one or more thickeners are present in a concentration of at least about 1 wt %, or from about 1 wt % to about 3 wt %; wherein the composition satisfies one or more of the following:
the weight ratio of the one or more optional corrosion inhibitors to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1; and
the weight ratio of the one or more optional thickeners to surfactant is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, or at least about 7.5:1.

10. (canceled)

11. The fire retardant composition of claim 1 wherein the fire retardant component comprises monoammonium phosphate (MAP) and/or diammonium phosphate (DAP); ammonium polyphosphate (APP); or phosphoric acid.

12. (canceled)

13. (canceled)

14. The fire retardant composition of claim 1, wherein the fire retardant component comprises a non-phosphate fire retardant selected from the group consisting of potassium carbonate, potassium bicarbonate, sodium carbonate, sodium bicarbonate, ammonium carbonate, ammonium bicarbonate, magnesium chloride, magnesium sulfate, ammonium chloride, ammonium bromide, ammonium sulfate, urea, dicyandiamide, melamine, cyanamide, and combinations thereof.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A liquid fire retardant composition, the composition comprising:
a fire retardant component comprising a phosphate fire retardant, wherein the fire retardant component constitutes at least about 85 wt % of the composition;
a surfactant selected from anionic surfactants, nonionic surfactants, and amphoteric surfactants, and combinations thereof, wherein the surfactant constitutes from about 0.01 wt % to about 1 wt % of the composition;
one or more optional corrosion inhibitors, wherein the weight ratio of the surfactant to the one or more corrosion inhibitors is from 0.01:1 to 1:1;
one or more optional pigments, wherein the weight ratio of the surfactant to the one or more pigments is from 0.01:1 to 1:1; and
one or more optional thickeners, wherein the weight ratio of the surfactant to the one or more pigments is from 0.01:1 to 1:1, wherein:
the liquid fire retardant composition has a surface tension that varies no more than 50% from the surface tension of water.

33. A liquid fire retardant composition, the composition comprising:
a fire retardant component comprising a phosphate fire retardant and a non-phosphate fire retardant, wherein the phosphate fire retardant constitutes at least about 50 wt % of the fire retardant component;
a surfactant selected from anionic surfactants, nonionic surfactants, and amphoteric surfactants; and
one or more optional components selected from corrosion inhibitors, pigments, thickeners, and combinations thereof, wherein:
the phosphate fire retardant comprises monoammonium phosphate (MAP), diammonium phosphate (DAP), ammonium polyphosphate (APP), phosphoric acid or a combination thereof;
the non-phosphate fire retardant is selected from the group consisting of potassium carbonate, potassium bicarbonate, sodium carbonate, sodium bicarbonate, ammonium carbonate, ammonium bicarbonate, magnesium chloride, magnesium sulfate, ammonium chloride, ammonium bromide, ammonium sulfate, urea, dicyandiamide, melamine, cyanamide or a combination of thereof;
the surfactant constitutes from about 0.01 wt % to about 1.0 wt % or from about 0.01 wt % to about 0.5 wt %; and
the liquid fire retardant composition has a surface tension that varies no more than 50% from the surface tension of water.

34. A liquid fire retardant composition, the composition comprising:
a fire retardant component comprising a phosphate fire retardant, wherein the phosphate fire retardant constitutes at least about 50 wt % of the fire retardant component;
an anionic surfactant, wherein the anionic surfactant constitutes from about 0.01 wt % to about 1 wt % of the composition; and
one or more optional components selected from corrosion inhibitors, pigments, thickeners, and combinations thereof, wherein:
the liquid fire retardant composition has a surface tension that varies no more than 50% from the surface tension of water; and
the anionic surfactant is selected from sulfonate type anionic surfactants selected from the group consisting of sodium pentanesulfonate, butylnaphtalenesulfonic acid sodium salt, sodium 1-butanesulfonate, lignofulonic acid calcium salt, sodium dodecylbenzene sulfonate, sodium allylsulfonate, sodium lignosulfonate, calcium dodecylbenzene sulfonate, 2-dodecylbenzenesulfonate, sodium alkylbenzene sulfonate, disodium methylenebisnaphthalenesulfphonate, ammonium dodecylbenzenesulphonate, linear alklybenzene sulfonates, and combinations thereof; and/or
the anionic surfactant is selected from sulfate type anionic surfactants selected from the group consisting of lithium dodecyl sulfate, sodium octyl sulfate, sodium dodecyl sulfate, sodium decyl sulfate, ammonium layryl sulfate, sodium lauryl polyoxyethylene ether sulfate, sodium lauryl sulfate, and combinations thereof; and/or
the anionic surfactant is selected from sulfosuccinate type anionic surfactants selected from the group consisting of sodium diisobutyl sulfosuccinate, dihexyl sodium sulfosuccinate, sodium diamyl sulfosuccinate, dicyclohexyl sulfosuccinate sodium salt, disodium 4-[2-[(1-oxoundec-10-enyl)amino]ethyl] 2-sulphonatosuccinate, and combinations thereof; and/or
the anionic surfactant is selected from fatty acid salt type anionic surfactants selected from the group consisting of sodium stearate, magnesium stearate, potassium oleate, hydroxyaluminum distearate, and combinations thereof; and/or
the anionic surfactant is selected from other types selected from of anionic surfactants comprising of organosilicon surfactant, fluorocarbon surfactant, fatty alcohol ammonium sulfate, soaps, and combinations thereof.

35. A liquid fire retardant composition, the composition comprising:
a fire retardant component comprising a phosphate fire retardant, wherein the phosphate fire retardant constitutes at least about 50 wt % of the fire retardant component;
a nonionic surfactant, wherein the nonionic surfactant constitutes from about 0.01 wt % to about 1 wt % of the composition; and
one or more optional components selected from corrosion inhibitors, pigments, thickeners, and combinations thereof, wherein:
the liquid fire retardant composition has a surface tension that varies no more than 50% from the surface tension of water; and
the nonionic surfactant is selected from polyethylene glycol monooleyl ether, polyethylene glycol monocetyl ether, polysorbate 20, polysorbate 40, Tween 60, Tween 80, polyoxyethylene lauryl ether, Span 60, dibenzyl biphenyl polyoxyethylene ether, fatty alcohol polyoxyethylene ether, alky polyglucoside, lauryl polyglucoside, sorbitan sesquioleate, silicone polyethers, and combinations thereof.

36. A liquid fire retardant composition, the composition comprising:
a fire retardant component comprising a phosphate fire retardant, wherein the phosphate fire retardant constitutes at least about 50 wt % of the fire retardant component;
an amphoteric surfactant, wherein the amphoteric surfactant constitutes from about 0.01 wt % to about 1 wt % of the composition; and
one or more optional components selected from corrosion inhibitors, pigments, thickeners, and combinations thereof, wherein:
the liquid fire retardant composition has a surface tension that varies no more than 50% from the surface tension of water; and
the amphoteric surfactant is selected from lauryl betaine, sodium lauroamphoacetate, lauramidopropyl betaine, cocoamidopropyl betaine, coco alkyldimethyl betaine, and combinations thereof.

37. (canceled)

38. (canceled)

39. (canceled)

40. (canceled)
